(19) United States
(12) Patent Application Publication
(10) Pub. No.: US 2014/0170035 A1
(43) Pub. Date: Jun. 19, 2014

(54) GASIFICATION SYSTEM AND METHOD OF ADJUSTING A PIPING ARRANGEMENT OF A GASIFICATION SYSTEM

(71) Applicant: GENERAL ELECTRIC COMPANY, Schenectady, NY (US)

(72) Inventor: Jerrold Samuel Kassman, Katy, TX (US)

(73) Assignee: GENERAL ELECTRIC COMPANY, Schenectady, NY (US)

(21) Appl. No.: 13/717,229

(22) Filed: Dec. 17, 2012

(51) Int. Cl. C10J 3/84; F16L 55/18

(52) U.S. Cl. CPC C10J 3/845; F16L 55/18
USPC 422/207; 137/15.01; 261/115

(57) ABSTRACT

A gasification system includes a reaction chamber having an inlet for receiving a feedstock for conversion to a gas. Also included is a quench chamber configured to cool the gas. Further included is a quench ring operably coupled to a water supply pipe for receiving water therein, the quench ring configured to provide a water flow to the quench chamber. Yet further included is a sealing component disposed at a coupling interface between the quench ring and the water supply pipe.

### BACKGROUND OF THE INVENTION

The subject matter disclosed herein relates to a gasification system, and more particularly to a quench ring arrangement, as well as a method of adjusting a piping arrangement of the gasification system.

Gasifiers convert carbonaceous materials into a mixture of carbon monoxide and hydrogen, referred to as synthesis gas or syngas. For example, an integrated gasification combined cycle (IGCC) power plant includes one or more gasifiers that react a feedstock at a high temperature with oxygen and/or steam to produce syngas. Upon gasification, the resulting syngas may include less desirable components, such as ash. Accordingly, the syngas may be directed through a quench unit to cool the syngas to a saturation temperature and remove the less desirable components as a slag. The quench unit includes a piping arrangement that includes a water supply pipe. Often, orientation misalignment during installation of the water supply pipe results in piping gaps that are too large for a fitting to close. Additionally, the piping may shift during operation. As a result, customization of certain components of the piping arrangement is required, which may include timely and costly activities such as cutting and welding of piping that is not easily accessible.

### BRIEF DESCRIPTION OF THE INVENTION

According to one aspect of the invention, a gasification system includes a reaction chamber having an inlet for receiving a feedstock for conversion to a gas. Also included is a quench chamber configured to cool the gas. Further included is a quench ring operably coupled to a water supply pipe for receiving water therein, the quench ring configured to provide a water flow to the quench chamber. Yet further included is a sealing component disposed at a coupling interface between the quench ring and the water supply pipe.

According to another aspect of the invention, a quench ring arrangement for a gasifier includes an annulus extending circumferentially around a bottom portion of a reaction chamber of the gasifier, the annulus configured to route water to a quench chamber. Also included is a water supply pipe operably coupled to the annulus for supplying water to the annulus, the water supply pipe operably coupled to the annulus with at least one mechanical fastener proximate a coupling interface. Further included is a packing gland disposed proximate the coupling interface for sealing water at the coupling interface during adjustment of the water supply pipe relative to the annulus.

According to yet another aspect of the invention, a method of adjusting a piping arrangement of a gasification system is provided. The method includes sealing an interface between a quench ring and a water supply pipe with a sealing component. Also included is adjusting the water supply pipe to align with a mating flange of the quench ring, wherein the sealing component reduces leakage of water during adjustment of the water supply pipe.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic illustration of a gasification system;

FIG. 2 is a partial cross-sectional view of a quench ring arrangement of the gasification system; and

FIG. 3 is a flow diagram illustrating a method of adjusting a piping arrangement of the gasification system.

The detailed description explains embodiments of the invention, together with advantages and features, by way of example with reference to the drawings.

### DETAILED DESCRIPTION OF THE INVENTION

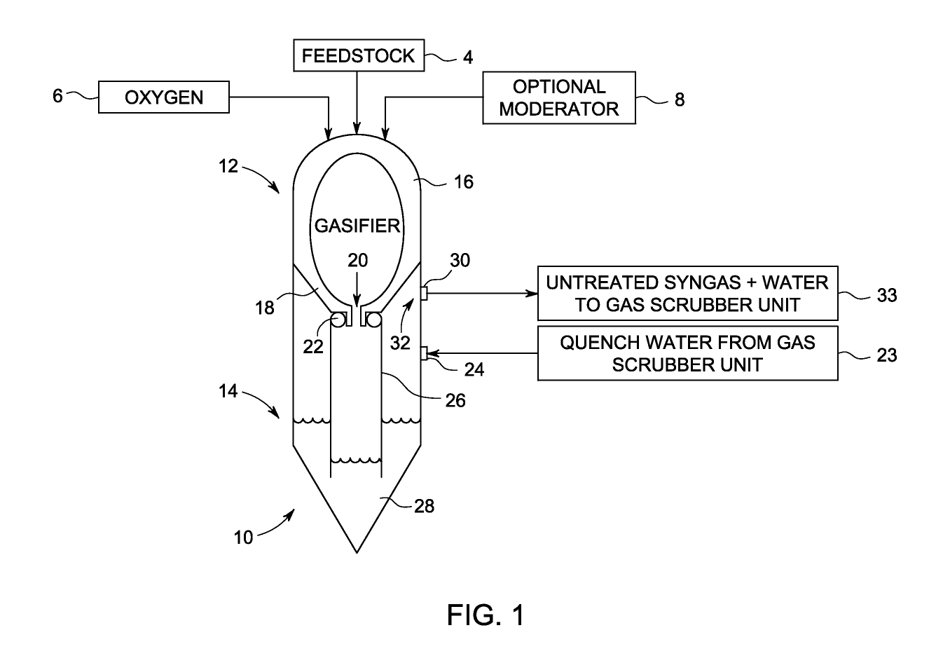

Referring to FIG. 1, a gasifier 10 is schematically illustrated. The gasifier 10 may be divided into a reaction chamber 12 and a quench chamber 14. In other embodiments, a synthetic gas cooler may be disposed between the reaction chamber 12 and the quench chamber 14. A protective barrier 16 may define the reaction chamber 12. The protective barrier 16 may act as a physical barrier, a thermal barrier, a chemical barrier, or any combination thereof. Examples of materials that may be used for the protective barrier 16 include, but are not limited to, refractory materials, refractory metals, non-metallic materials, clays, ceramics, cermets, and oxides of aluminum, silicon, magnesium, and calcium. In addition, the materials used for the protective barrier 16 may be bricks, castable coatings, or any combination thereof. A feedstock 4, along with oxygen 6 and an optional moderator 8, such as steam, may be introduced through one or more inlets into the reaction chamber 12 of the gasifier 10 to be converted into a raw or untreated synthetic gas, e.g., a combination of carbon monoxide and hydrogen, which may also include slag and other contaminants. In certain embodiments, air or oxygen-enhanced air may be used instead of the oxygen 6. The untreated synthesis gas may also be described as untreated gas.

The conversion in the gasifier 10 may be accomplished by subjecting the feedstock to steam and oxygen at elevated pressures, e.g., from approximately 20 bar to 100 bar, or to 85 bar, and temperatures, e.g., about 1100° C. (about 2012° F.) to 1450° C. (about 2642° F.), depending on the type of the gasifier 10 utilized. Under these conditions, the slag is in the molten state and is referred to as molten slag. In other embodiments, the molten slag may not be entirely in the molten state. For example, the molten slag may include solid (non-molten) particles suspended in molten slag.

The high-pressure, high-temperature untreated synthetic gas from the reaction chamber 12 may enter the quench chamber 14 through a bottom end 18 of the protective barrier 16, as illustrated by arrow 20. In other embodiments, the untreated synthetic gas passes through the syngas cooler before entering the quench chamber 14. In general, the quench chamber 14 may be used to reduce the temperature of the untreated synthetic gas. In certain embodiments, a quench ring arrangement 22 may be located proximate to the bottom end 18 of the protective barrier 16. The quench ring arrangement 22 is configured to provide quench water to the quench chamber 14. In certain embodiments, the configuration of the protective barrier 16 may protect the quench ring arrangement 22 from the synthetic gas and/or molten slag. As illustrated, quench water 23 from a gas scrubber unit 33 may be received through a water supply pipe 24 into the quench chamber 14. Generally, the quench water 23 may flow through the quench ring arrangement 22 and down a dip tube 26 into a quench chamber sump 28. As such, the quench water 23 may cool the untreated synthetic gas, which may subsequently exit the quench chamber 14 through a synthetic gas outlet 30 after being cooled, as illustrated by arrow 32.

In other embodiments, a coaxial draft tube may surround the dip tube 26 to create an annular passage through which the untreated synthetic gas may rise. In further embodiments, a spray quench system may be used to help cool the untreated synthetic gas. The synthetic gas outlet 30 may generally be located separate from and above the quench chamber sump 28 and may be used to transfer the untreated synthetic gas and any water to the gas scrubber unit 33 for treatment. For example, the gas scrubber unit 33 may remove fine solid particles and other contaminants. In addition, the gas scrubber unit 33 may remove entrained water from the untreated synthetic gas, which may then be used as quench water within the quench chamber 14 of the gasifier 10. The treated synthetic gas from the gas scrubber unit 33 may ultimately be directed to a chemical process or a combustor of a gas turbine engine, for example.

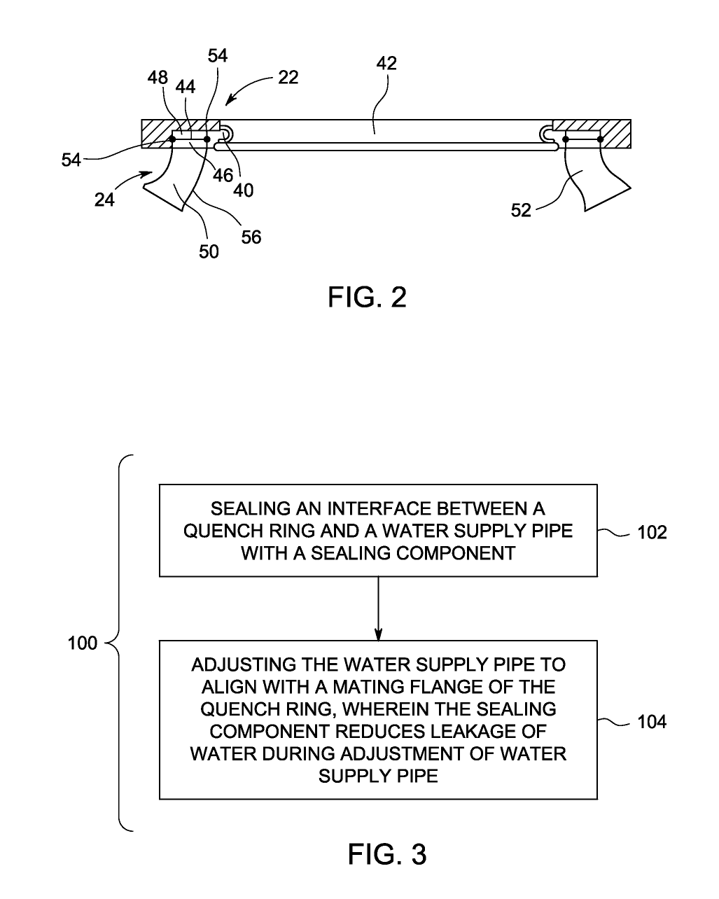

Referring now to FIG. 2, a partial cross-sectional view of the quench ring arrangement 22 is illustrated in greater detail. The quench ring arrangement 22 includes an annulus 40 extending circumferentially around a bottom portion 42 of the reaction chamber 12, such that the annulus 40 forms a conduit for routing the quench water 23 to the quench chamber sump 28. As illustrated, the quench water 23 is provided to the quench ring arrangement 22 via the water supply pipe 24. The water supply pipe 24 is operably coupled to the quench ring arrangement 22, and more specifically to the annulus 40. Such a connection is made at a coupling interface 44 disposed proximate the water supply pipe 24 and the annulus 40, with the connection facilitated by one or more mechanical fasteners, for example. The coupling interface 44 is defined by engagement of an interface flange 46 operably coupled to or integrally formed with the water supply pipe 24 and a mating flange 48 operably coupled to or integrally formed with the quench ring arrangement 22. As illustrated, a plurality of water supply pipes may be included, such as a first water supply pipe 50 and a second water supply pipe 52 operably coupled to the quench ring arrangement 22 in a circumferentially spaced manner. In the illustrated embodiment, the first water supply pipe 50 and the second water supply pipe 52 are spaced about 180° apart around the quench ring arrangement 22, but it is to be appreciated that more water supply pipes may be included and spaced in alternative arrangements. Irrespective of the precise number of water supply pipes and of their orientation to one another, each of the plurality of water supply pipes include similar engagement configurations to the quench ring arrangement 22 at the coupling interface 44.

Disposed proximate the coupling interface 44 is a sealing component 54. The sealing component 54 comprises a packing gland, such as a stuffing box, for example. In an exemplary embodiment, the sealing component 54 is coupled to the mating flange 48 and is positioned radially outwardly of an outer surface 56 of the water supply pipe 24. The sealing component 54 includes a radially expanding and soft, flexible packing material within the stuffing box to control leakage of the quench water 23 flowing through the water supply pipe 24 proximate the coupling interface 44. The soft, flexible packing material fills a cavity between the outer surface of the water supply pipe 24 and the quench ring arrangement 22, specifically the packing box. Although the sealing component 54 is described above as being coupled to the mating flange 48, the sealing component 54 may alternatively be coupled to the interface flange 46 of the water supply pipe 24.

Advantageously, inclusion of the sealing component 54 increases the ease of adjustment of the water supply pipe 24 to ensure proper alignment between the water supply pipe 24 and the quench ring arrangement 22. Maneuvering the water supply pipe 24 while still engaged with the quench ring arrangement 22 alleviates the need for complete or partial disassembly and machining of the water supply pipe 24 and/or the quench ring arrangement 22. Leakage concerns regarding adjustment of the water supply pipe 24 during engagement with the quench ring arrangement 22 are addressed by radial expansion and compression of the sealing component 54 during adjustment.

As illustrated in the flow diagram of FIG. 3, and with reference to FIGS. 1 and 2, a method of adjusting a piping arrangement of a gasification system 100 is also provided. The gasifier 10, and more specifically the water supply pipe 24 and the quench ring arrangement 22 have been previously described and specific structural components need not be described in further detail. The method of adjusting a piping arrangement of a gasification system 100 includes sealing an interface between a quench ring and a water supply pipe with a sealing component 102. The water supply pipe is adjusted to align with a mating flange of the quench ring, wherein the sealing component reduces leakage of water during adjustment of the water supply pipe 104. As described in detail above, a packing gland, such as a stuffing box, is disposed proximate the interface to reduce leakage to an acceptable level during adjustment of the water supply pipe 24.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A gasification system comprising:
a reaction chamber having an inlet for receiving a feedstock for conversion to a gas;
a quench chamber configured to cool the gas;
a quench ring operably coupled to a water supply pipe for receiving water therein, the quench ring configured to provide a water flow to the quench chamber; and
a sealing component disposed at a coupling interface between the quench ring and the water supply pipe.

2. The gasification system of claim 1, wherein the sealing component comprises a packing gland.

3. The gasification system of claim 1, wherein the sealing component comprises a stuffing box.

4. The gasification system of claim 1, wherein the coupling interface comprises engagement of an interface flange of the water supply pipe and a mating flange of the quench ring.

5. The gasification system of claim 4, wherein the interface flange and the mating flange are mechanically fastened to each other.

6. The gasification system of claim 4, wherein the sealing component is coupled to the interface flange.

7. The gasification system of claim 4, wherein the sealing component is coupled to the mating flange.

8. The gasification system of claim 1, further comprising a plurality of water supply pipes operably coupled to the quench ring, each of the plurality of water supply pipes having the sealing component disposed in close proximity thereto.

9. The gasification system of claim 8, wherein the plurality of water supply pipes comprises a first water supply pipe and a second water supply pipe spaced about 180 degrees relative to each other along the quench ring.

10. A quench ring arrangement for a gasifier comprising:
an annulus extending circumferentially around a bottom portion of a reaction chamber of the gasifier, the annulus configured to route water to a quench chamber;
a water supply pipe operably coupled to the annulus for supplying water to the annulus, the water supply pipe operably coupled to the annulus with at least one mechanical fastener proximate a coupling interface; and
a packing gland disposed proximate the coupling interface for sealing water at the coupling interface during adjustment of the water supply pipe relative to the annulus.

11. The quench ring arrangement of claim 10, wherein packing gland is disposed proximate an outer surface of the water supply pipe.

12. The quench ring arrangement of claim 10, wherein the packing gland comprises a stuffing box.

13. The quench ring arrangement of claim 10, wherein the coupling interface comprises engagement of an interface flange of the water supply pipe and a mating flange of the quench ring arrangement.

14. The quench ring arrangement of claim 13, wherein the interface flange and the mating flange are mechanically fastened to each other.

15. The quench ring arrangement of claim 13, wherein the packing gland is coupled to the interface flange.

16. The quench ring arrangement of claim 13, wherein the packing gland is coupled to the mating flange.

17. The quench ring arrangement of claim 10, further comprising a plurality of water supply pipes operably coupled to the annulus, each of the plurality of water supply pipes having the packing gland disposed in close proximity thereto.

18. The quench ring arrangement of claim 17, wherein the plurality of water supply pipes comprises a first water supply pipe and a second water supply pipe spaced about 180 degrees relative to each other along the annulus.

19. A method of adjusting a piping arrangement of a gasification system comprising:
sealing an interface between a quench ring and a water supply pipe with a sealing component; and
adjusting the water supply pipe to align with a mating flange of the quench ring, wherein the sealing component reduces leakage of water during adjustment of the water supply pipe.

20. The method of claim 19, wherein sealing the interface comprises disposing a packing gland in operable engagement with at least one of the mating flange and an interface flange of the water supply pipe.
